(19) United States
(12) Patent Application Publication
(10) Pub. No.: US 2020/0223416 A1
(43) Pub. Date: Jul. 16, 2020

(54) BRAKING DEVICE FOR A WORKING MACHINE

(71) Applicant: Liebherr-Hydraulikbagger GmbH, Kirchdorf an der Iller (DE)

(72) Inventors: Bernhard MEITINGER, Buxheim (DE); Markus SCHROPP, Obergünzburg (DE); Markus MUECKL, Oy-Mittelberg (DE); Alexander PURR, Weifßenhorn (DE)

(21) Appl. No.: 16/742,414

(22) Filed: Jan. 14, 2020

(30) Foreign Application Priority Data
Jan. 15, 2019 (DE) 10 2019 100 935.9

(51) Int. Cl. B60T 13/68; B60T 8/17; B60T 8/24; B60T 8/18; B60T 13/58; B60T 8/32; B60T 7/04

(52) U.S. Cl. CPC B60T 13/686; B60T 8/1701; B60T 8/246; B60T 8/18; B60T 13/586; B60T 2250/04; B60T 8/326; B60T 7/042; B60T 2270/82; B60T 2220/04; B60T 8/17

(57) ABSTRACT

The invention relates to a braking device for a work machine comprising a pressure supply, a brake circuit, at least one brake actuable via the brake circuit, a manually controllable brake valve by means of which the brake circuit is actuable, a control unit, and at least one control valve that is controllable by the control unit and by means of which the brake circuit is actuable. In accordance with the invention, the total brake torque exerted by the at least one brake is adjustable by means of a corresponding control or regulation of the at least one control valve in dependence on at least two input signals detectable by the control unit, with a first input signal relating to a current state of the manual actuation of the brake valve and a second input signal relating to a current driving state of the work machine

The present invention relates to a braking device for a work machine in accordance with the preamble of claim 1.

Braking devices are known in vehicles and in mobile work machines. They are frequently control or regulation systems that can be manually controlled by the operator of the work machine. Corresponding brake pedals or other actuation devices are typically provided in the driver's cabin for this purpose and a braking procedure can be manually initiated and controlled by means of them.

A large number of work machines are equipped with braking devices (e.g. dual circuit braking systems) in which the brake circuit that actuates the service brakes is manually controllable via a brake valve—typically via a brake pedal coupled to the brake valve. As a rule the braking pressure to brake pedal angle characteristic of the manually actuable brake valve is predefined and not adaptable.

It is a disadvantage with this solution that differences in the brake retardation result that are substantial in part in different driving situations with a predefined dependence of the brake torque of the work machine on the brake pedal position. A fully loaded work machine, for example, reacts differently than in a less loaded or unloaded state with the same brake torque or with the same brake pedal position. The brake retardation is likewise dependent on the ascending gradient of the terrain or of the driving surface and on the driving speed of the work machine with the same brake pedal position.

The different braking behavior in the respective driving situations therefore requires increased attention and experience of the operator of the work machine and necessarily encompasses an increased safety risk.

Against this background, it is the underlying object of the present invention to improve the braking behavior of work machines.

This object is satisfied in accordance with the invention by a braking device for work machines having the features of claim 1. The braking device accordingly comprises a pressure supply, a brake circuit, at least one brake actuable via the brake circuit, a manually controllable brake valve by means of which the brake circuit is actuable, a control unit, and at least one control valve that is controllable by the control unit and by means of which the brake circuit is actuable.

In accordance with the invention, the total brake torque exerted on the work machine by the at least one brake can be set in dependence on at least two input signals detectable by the control unit by means of a corresponding control or regulation of the at least one control valve. In this respect, a first input signal relates to a current state of the manual actuation of the brake valve and a second input signal relates to a current driving state or driving situation of the work machine.

A setting of the total brake torque adapted to the current driving situation therefore takes place by the braking device in accordance with the invention in that a corresponding electronic control or regulation of the at least one control valve is carried out by the control unit. It is thereby possible to compensate the effects on the braking behavior of the work machine that result from specific driving situations such as the ascending/descending gradient, load, driving speed, surface condition, steering angle or articulation angle, etc. and to thereby to improve the braking behavior for the operator or driver.

Not only signals relating to the current driving situation enter into the control unit, but also information on the current state of the manual actuation of the brake valve (e.g. the brake pedal angle). The braking behavior of the work machine is thereby adapted to the current driving situation in dependence on the desired braking force, i.e. in dependence on by how much the operator would like to brake the work machine at a given point in time.

Advantageous embodiments of the invention result from the independent claims and from the following description.

Provision is made in an embodiment that an actuation means, preferably a brake pedal, is provided that is connected to the brake valve, with the brake valve being able to be controlled or regulated by means of a manual actuation of the actuation means and with the first input signal relating to a current position of the actuation means, in particular the current angle of the brake pedal. The current position of the actuation means can be detected by means of a sensor, for example. With a brake pedal, for example, the pedal angle is representative for the desired braking force so that a sensor can be provided for detecting the brake pedal angle. A braking pressure can thus be generated in the brake circuit in dependence on the angle position of the brake pedal, with information with respect to the brake pedal angle likewise being transmitted to the control unit. The control of the brake valve can then take place either directly or likewise via the control unit.

Provision is made in a further embodiment that the current driving state of the work machine relates to the weight or the load, the speed, the steering angle, the articulation angle, and/or a switching state of limited slip differentials of the work machine and/or to the surface condition and/or the ascending gradient (i.e. the angle of an ascending or descending terrain) of the surface. Provision can likewise be made to detect whether the surface is wet or dry.

This current driving state is preferably detectable by means of one or more sensors. Depending on the parameter to be detected, it can be a pressure sensor or a weighing device, a speed sensors, an articulation angle sensor, a steering angle sensor, and/or a sensor for detecting the surface condition (e.g. a camera or a different optical sensor).

The current driving state or driving situation is therefore ideally detected directly and automatically and is transmitted to the control unit so that an adaptation of the total brake torque can take place in real time. The driver of the work machine is thereby relieved since he does not himself have to take account of the current driving conditions or only has to do so to a limited extent. The safety risk that necessarily results from the human component of the control of the work machine is thereby reduced.

Provision is made in a further embodiment that, by the setting of the total brake torque, the brake retardation of the work machine can be set to a value that is independent of the current driving state and that is preferably dependent on the first input signal. It is therefore achieved by a brake torque adapted to the current driving situation that the brake retardation of the work machine no longer depends, or only depends to a lesser degree, on the current driving situation (this depends on how many factors characterizing the driving state are detected and are included in the adaptation of the total brake torque). For example, as is known, the braking distance of a work machine increases in the loaded state, at increased speed, or when driving down a gradient. In such situations, the control unit can, for example, automatically bring about a reduction of the brake retardation or of the braking distance by an increase in the total brake torque so that an unchanging braking behavior results for the operator. Conversely, a reduction in the total brake torque, in particular at a specific brake pedal position, by the control unit can result in an increase in the brake retardation in the presence of an upward gradient or in an unloaded state.

The brake retardation fixed to a specific value by a corresponding adaptation of the total brake torque is ideally dependent on the position of the actuation element, that is, for example, on the brake pedal angle.

Provision is made in a further embodiment that to set the brake retardation, the characteristic of the total brake torque to the position of the actuation means can be changed by the control unit. This can take place, for example, by the superposition of a characteristic of the at least one control valve settable by the control unit on a characteristic (in particular the braking pressure-to brake pedal angle characteristic) of the brake valve. A change of the curve of the characteristic, an increase or a decrease of the characteristic can take place, for example, depending on the arrangement and control of the at least one control valve.

Provision is made in a further embodiment that the braking device comprises at least two brake circuits each having at least one brake, with each brake circuit comprising at least one control valve controllable by the control unit and with the control valves of the different brake circuits preferably being able to be controlled or regulated independently of one another. Different brake circuits can, for example, be provided for different axles and/or differentials of the work machine so that they can be braked independently of one another. A respective separate control valve that is controlled or regulated by the control unit is provided for each of these brake circuits for this purpose. The manner of how the different brake circuits are actuated depends on the current driving state that is transmitted to the control unit by means of the at least one second input signal. The current driving state can also relate to a switching state of a plurality of limited slip differentials.

Provision is made in a further embodiment that the braking device comprises a retarder that can be controlled or regulated by the control unit and/or an engine brake that can be controlled or regulated by the control unit and that contributes to the total brake torque and can preferably be controlled or regulated by the control unit in dependence on the current state of the manual actuation of the brake valve and/or on the current driving state.

Provision is made in a further embodiment that the brake valve and at least one control valve are connected in parallel and are connected to the brake circuit via at least one shuttle valve. The brake valve and the at least one control valve can be supplied with fluid via a common pressure supply or via different pressure supplies. A pressures store can additionally be connected upstream of the control valve to be able to adapt the applied pressure in comparison with the pressure applied to the brake valve, in particular on a use of a common pressure source or pressure supply.

Provision is made in a further embodiment that that at least one safety valve is connected in series downstream of the brake valve. A pressure relief to a tank can preferably take place via this safety valve.

A combination of control valves connected in parallel and in series can also be present. The brake valve and/or the at least one control valve can be designed as proportional valves.

The present invention further relates to a work machine, in particular an excavator, dumper, wheeled loader, or flatbed truck, having a braking device in accordance with the invention. The same advantages and properties obviously result in this respect as for the braking device in accordance with the invention so that a repeat description at this point is dispensed with.

Further features, details and advantages of the invention result from the embodiments explained in the following with reference to the Figures. There are shown:

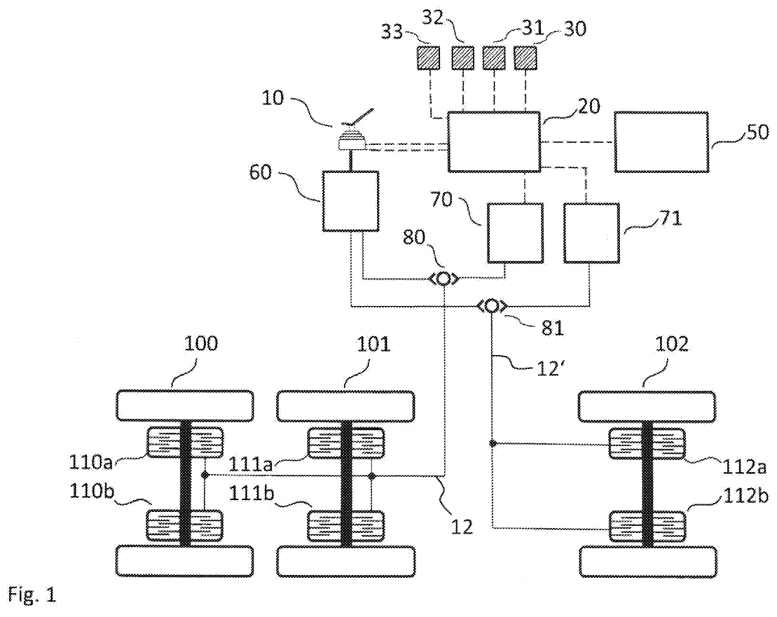

FIG. 1: a schematic representation of a first embodiment of the braking device in accordance with the invention;

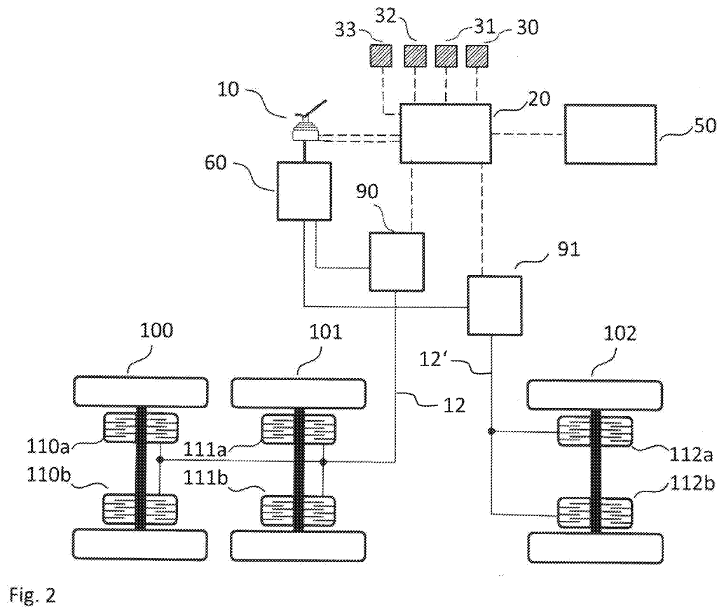

FIG. 2: a schematic representation of a second embodiment of the braking device in accordance with the invention;

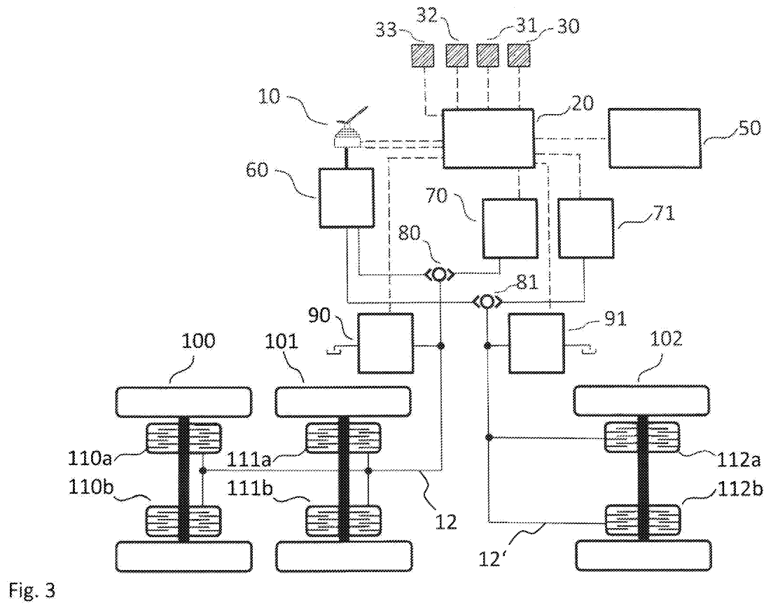

FIG. 3: a schematic representation of a third embodiment of the braking device in accordance with the invention;

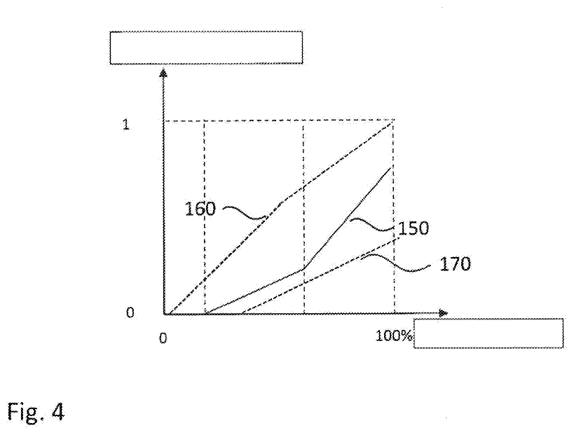

FIG. 4: a diagram with possible characteristics of the brake valve and of the at least one control valve; and

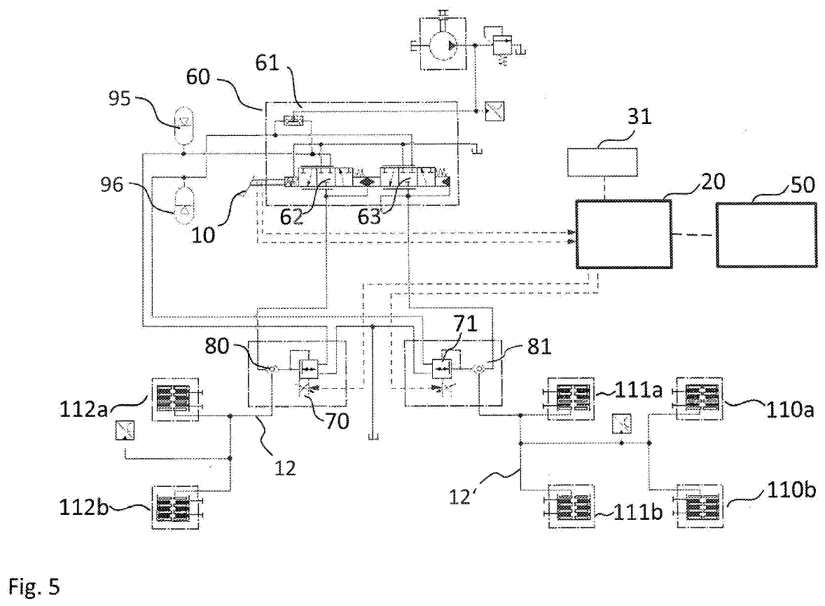

FIG. 5: a representation of a fourth embodiment of the braking device in accordance with the invention.

A first embodiment of the braking device for a work machine in accordance with the invention is shown schematically in FIG. 1. The work machine can be an excavator, dumper or dump truck, wheeled loader, flatbed truck, or another construction machine. The braking device comprises a plurality of brakes 110a-b, 111a-b, 112a-b that are arranged at different axles 100, 101, 102 of the work machine and that are used to brake the respective axles 100, 101, 102 or differentials of the respective axles 100, 101, 102. The brakes 110a-b, 111a-b, 112a-b are actuated via two hydraulic brake circuits 12, 12′, with brake circuit 12 being associated with the brakes 110a-b and 111a-b and brake circuit 12′ being associated with the brakes 112a-b. The axles 100 and 101 in the present case can be the rear axles and the axle 102 can be the front axle of an articulation-steered dumper.

The braking device comprises a brake pedal 10 manually actuable by the operator of the work machine and having an integrated angle sensor (not shown) to detect the brake pedal position. The brake pedal 10 is connected to a brake valve 60 that is here designed as a two-circuit brake valve and supplies both brake circuits 12, 12′ or regulates the braking pressure in the brake circuits (12, 12′). An actuation of the brake valve 60 triggered by manual actuation of the brake pedal 10 produces an increase in the braking pressure in both brake circuits 12, 12′ and thus an actuation of the brakes 110a-b, 111a-b, 112a-b. A braking pressure is thus produced by the coupling of the brake pedal 10 and the brake valve 60 in dependence on the angle position of the brake pedal 10. The brake circuits 12, 12′ are in particular connected to a pressure supply (not shown) via the brake valve 60. The brake valve 60 is directly actuated via the brake pedal 10. Provision can, however, also be made that an actuation takes place via the control unit 20 or via a further electronic unit.

Each of the brake circuits 12, 12′ furthermore comprises an electrically controllable control valve 70, 71 that is connected to the brake valve 60 via a respective shuttle valve 80, 81. The shuttle valves 80, 81 connect the brakes 110a-b, 111a-b, 112a-b to the brake valve 60 or to the control valves 70, 71 depending on whether the pressure generated by the control valves 70, 71 or the pressure generated by the brake valve 60 is the greater. The brake circuits 12, 12′ are therefore actuable both via the brake valve 60 and via the control valves 70, 71.

The work machine furthermore comprises a control unit 20 that receives signals of the angle sensor of the brake pedal 10 (first input signal). The control unit 20 in this embodiment furthermore receives signals from a speed sensor 30 to detect the driving speed of the work machine, from a weighing device 31 to detect the load or the load state of the work machine, from a steering angle sensor or an articulation angle sensor 32 to detect the steering angle or articulation angle of the work machine, and a sensor 33 to recognize the surface condition (for example a camera). The sensors 30-33 deliver information on the current driving state to the control unit 20 via corresponding signals.

The control unit 20 is electrically connected to the control valves 70, 71 and can electrically control or regulate them independently of one another. The braking device furthermore comprises a retarder 50 that is likewise controlled or regulated by the control unit 20. The control units 70, 71 are connected in parallel with the brake valve 60 and can be connected to the same pressure source or to one or more separate pressure sources.

The control unit 20 calculates a desired current value on the basis of the signals of the sensors 30-33 and controls the control valves 70, 71 with this desired current value. A corresponding pressure is thereby built up in the brake circuits 12, 12′ or the brakes 110a-b, 111a-b, 112a-b by the control valves 70, 71 that corresponds to a specific total brake torque that depends on the sensor signals 30-33 and on the current angle position of the brake pedal 10.

The total brake torque that is exerted on the work machine by the brakes 110a-b, 111a-b, 112a-b can be adapted to the current driving situation by the use of the additional control valves 70, 71 to control the brake pressure in the brake circuits 12, 12′. A brake retardation independent of the driving situation can thereby be achieved.

The brake retardation is produced from, in addition to other factors, the brake pedal position, the driving speed, the load of the work machine, the steering angle or articulation angle, the switching state of the limited slip differentials (e.g. an inter-axle differential lock and an inter-wheel differential lock), the brake characteristics of the different axles 100, 101, 102 (that can be identical or different), the ascending gradient angle of the terrain or driving surface (ascending or descending gradient), and the surface conditions.

The total brake torque M_{Total} produced by the brakes 110a-b, 111a-b, 112a-b can be adapted to the aforesaid situations and factors and results from the following relationship:

M_{Total}=M_{Des.}−M_{Perm.}

Here M_{Des.} designates the desired brake torque produced by the brake valve 60 and the control valves 70, 71 and M_{Perm.} designates the brake torque that is produced by possible additional permanent brake devices. In the present case, it is the retarder 50 (M_{Perm.}=M_{Retarder}), but alternatively or additionally further permanent brake devices such as an engine brake can be present. With a combination of a retarder 50 and an engine brake, M_{Perm.} is calculated as:

M_{Perm.}=M_{Retarder}+M_{Engine}

M_{Retarder} here designates the brake torque produced by the retarder 50 and M_{Engine} designates the brake torque produced by the engine brake. The desired brake torque in particular depends on the desired current value produced in the control unit 20.

The total brake torque is adapted to the above-named factor so that the brake retardation on a specific brake pedal position is always independent of the respective driving situation.

A second embodiment of the braking device in accordance with the invention is shown schematically in FIG. 2. Unlike the first embodiment of FIG. 1, the control valves 90, 91 are here not arranged in parallel with the brake valve 60 and connected thereto and to the brakes via shuttle valves 80, 81, but are connected in series downstream of the brake valve 60 in the respective brake circuits 12, 12′. It is thereby possible to reduce the brake pressure the manually actuated brake valve 60 produces. However, no higher pressure than the pressure produced by the brake valve 60 can be imparted to the brake circuits 12, 12′.

A third embodiment of the braking device in accordance with the invention is shown schematically in FIG. 3. In this variant, the advantages of the embodiments shown in FIGS. 1 and 2 are combined. In addition to the control valves 70, 71 already known from the first embodiment and arranged in parallel with the brake valve 60, a respective further control valve 90, 91 is arranged in the brake circuits 12, 12′ that can be controlled or regulated by the control unit 20 and that connects the respective brake circuit 12, 12′ to a tank or discharges to it on a corresponding actuation. The control valves 90, 91 are arranged in series with the shuttle valves 80, 81 and are thus connected downstream of the brake valve 60 and the control valves 70, 71.

The brake pressure produced by a manual actuation of the brake pedal 10 by means of the brake valve 60 can thereby be both increased by a corresponding control of the parallel control valves 70, 71 and decreased by a corresponding control of the control valves 90, 91 connected downstream.

Three different brake torque-to-brake pedal angle characteristics 150, 160, 170 are shown in a common diagram in FIG. 4. The characteristic 150 corresponds to the characteristic of the brake valve 60 while the characteristics 160 and 170 show possible characteristics of the parallel control valves (FIGS. 1 and 3, control valves 70, 71) and of the control valves (FIGS. 2 and 3, control valves 90, 91) connected downstream. It can additionally be possible to adapt the characteristics by a corresponding control or regulation of the retarder 50 and/or of an engine brake possibly likewise provided.

A brake retardation independent of the driving situation can be achieved for a given brake pedal angle by a corresponding superposition of the characteristic 150 of the brake valve 60 on the characteristics of the control valves 70, 71, 90, 91.

The characteristic 160 can, for example, be superposed on the characteristic 150 of the brake valve 60 by means of the control valves 70, 71 in a state in which the work machine is loaded so that the brake retardation corresponds to that in the unloaded state. In an unloaded state or on the presence of an ascending gradient (driving uphill), the characteristic 150 can in contrast be reduced to the characteristic 170 by the control valves 90, 91.

In certain cases, it can also be necessary to feed different brake pressures for the different axles 100, 101, 102 in dependence on the above-named sensor signals 30-33. The brake pressure at the rear axle or rear axles can, for example, be reduced in dependence on the steering angle.

FIG. 5 shows a fourth embodiment of the braking device in accordance with the invention in a detailed schematic representation that substantially corresponds to the solution variant shown in FIG. 1 with two control valves 70, 71 that are arranged in parallel with the brake valve 60 and that are formed as proportional pressure reducing valves here. The brake valve 60 comprises two proportional valves 62, 63 that are actuable by the brake pedal 10 and that connect the common pressure supply 61 to the two brake circuits 12, 12′. Both brake circuits 12, 12′ and the pressure supply 61 additionally have pressure sensors. The same pressure source connected to the pressure supply 61 also supplies the control valves 70, 71, with two pressure stores 95, 96 additionally being present here.

### REFERENCE NUMERAL LIST

10 brake pedal
12 brake circuit
12′ brake circuit
20 control unit
30 speed sensor
31 weighing device
32 steering angle sensor
33 surface detection sensor
50 retarder
60 brake valve
61 pressure supply
62 proportional valve
63 proportional valve
70 control valve
71 control valve
80 shuttle valve
81 shuttle valve
90 control valve
91 control valve
95 pressure store
96 pressure store
100 axle
101 axle
102 axle
110a-b brake
111a-b brake
112a-b brake
150 brake valve characteristic
160 control valve characteristic
170 control valve characteristic

1. A braking device for a work machine comprising a pressure supply (61), a brake circuit (12, 12′), at least one brake (110a-b, 111a-b, 112a-b) actuable via the brake circuit (12, 12′), a manually controllable brake valve (60) by which the brake circuit (12, 12′) is actuable, a control unit (20), and at least one control valve (70, 71, 90, 91) that is controllable by the control unit (20) and by which the brake circuit (12, 12′) is actuable, wherein
the total brake torque exerted by the at least one brake (110a-b, 111a-b, 112a-b) is adjustable by a corresponding control or regulation of the at least one control valve (70, 71, 90, 91) in dependence on at least two input signals detectable by the control unit (20), with a first input signal relating to a current state of the manual actuation of the brake valve (60) and a second input signal relating to a current driving state of the work machine.

2. A braking device in accordance with claim 1, wherein an actuation means (10), preferably a brake pedal (10), is provided that is connected to the brake valve (60), with the brake valve (60) being controllable by a manual actuation of the actuation means (10) and with the first input signal relating to a current position of the actuation means (10), in particular to the current angle of the brake pedal (10), said current position preferably being detectable by a sensor.

3. A braking device in accordance with claim 1, wherein the current driving state of the work machine relates to the weight, the load, the speed, the steering angle, the articulation angle, and/or a switching state of limited slip differentials of the work machine and/or to the surface condition and/or the ascending gradient of the surface and is preferably detectable by a sensor (30, 31, 32, 33).

4. A braking device in accordance with claim 1, wherein, by the setting of the total brake torque, the brake retardation of the work machine can be set to a value that is independent of the current driving state and that is preferably dependent on the first input signal.

5. A braking device in accordance with claim 2, wherein to set the brake retardation, the characteristic of the total brake torque to the position of the actuation means (10) can be changed by the control unit (20), in particular by superposing a characteristic of the at least one control valve (70, 71, 90, 91) settable by the control unit (20) on a characteristic of the brake valve (60).

6. A braking device in accordance with claim 1, wherein the braking device comprises at least two brake circuits (12, 12′) each having at least one brake (110a-b, 111a-b, 112a-b), each brake circuit (12, 12′) comprises at least one control valve (70, 71, 90, 91) controllable by the control unit (20), the control valves (70, 71, 90, 91) of the different brake circuits (12, 12′) can preferably be controlled or regulated independently of one another, and the brake valve (60) is preferably designed as a two-circuit brake valve (60).

7. A braking device in accordance with claim 1, wherein the braking device comprises a retarder (50) that can be controlled or regulated by the control unit (20) and/or an engine brake that can be controlled or regulated by the control unit (20), that contributes to the total brake torque, and preferably be controlled or regulated by the control unit (20) in dependence on the current state of the manual actuation of the brake valve (60) and/or on the current driving state.

8. A braking device in accordance with claim 1, wherein the brake valve (60) and at least one control valve (70, 71) are connected in parallel and to the brake circuit (12, 12′) via at least one shuttle valve (80, 81).

9. A braking device in accordance with claim 1, wherein at least one control valve (90, 91) is connected in series downstream of the brake valve (60).

10. A work machine having a braking device in accordance with claim 1.

11. A braking device in accordance with claim 2, wherein the current driving state of the work machine relates to the weight, the load, the speed, the steering angle, the articulation angle, and/or a switching state of limited slip differentials of the work machine and/or to the surface condition and/or the ascending gradient of the surface and is preferably detectable by a sensor (30, 31, 32, 33).

12. A braking device in accordance with claim 11, wherein, by the setting of the total brake torque, the brake retardation of the work machine can be set to a value that is independent of the current driving state and that is preferably dependent on the first input signal.

13. A braking device in accordance with claim 3, wherein, by the setting of the total brake torque, the brake retardation of the work machine can be set to a value that is independent of the current driving state and that is preferably dependent on the first input signal.

14. A braking device in accordance with claim 2, wherein, by the setting of the total brake torque, the brake retardation of the work machine can be set to a value that is independent of the current driving state and that is preferably dependent on the first input signal.

15. A braking device in accordance with claim 4, wherein to set the brake retardation, the characteristic of the total brake torque to the position of the actuation means (10) can be changed by the control unit (20), in particular by superposing a characteristic of the at least one control valve (70, 71, 90, 91) settable by the control unit (20) on a characteristic of the brake valve (60).

16. A braking device in accordance with claim 14, wherein to set the brake retardation, the characteristic of the total brake torque to the position of the actuation means (10) can be changed by the control unit (20), in particular by superposing a characteristic of the at least one control valve (70, 71, 90, 91) settable by the control unit (20) on a characteristic of the brake valve (60).

17. A braking device in accordance with claim 13, wherein to set the brake retardation, the characteristic of the total brake torque to the position of the actuation means (10) can be changed by the control unit (20), in particular by superposing a characteristic of the at least one control valve (70, 71, 90, 91) settable by the control unit (20) on a characteristic of the brake valve (60).

18. A braking device in accordance with claim 12, wherein to set the brake retardation, the characteristic of the total brake torque to the position of the actuation means (10) can be changed by the control unit (20), in particular by superposing a characteristic of the at least one control valve (70, 71, 90, 91) settable by the control unit (20) on a characteristic of the brake valve (60).

19. A braking device in accordance with claim 5, wherein the braking device comprises at least two brake circuits (12, 12′) each having at least one brake (110a-b, 111a-b, 112a-b), each brake circuit (12, 12′) comprises at least one control valve (70, 71, 90, 91) controllable by the control unit (20), the control valves (70, 71, 90, 91) of the different brake circuits (12, 12′) can preferably be controlled or regulated independently of one another, and the brake valve (60) is preferably designed as a two-circuit brake valve (60).

20. A braking device in accordance with claim 4, wherein the braking device comprises at least two brake circuits (12, 12′) each having at least one brake (110a-b, 111a-b, 112a-b), each brake circuit (12, 12′) comprises at least one control valve (70, 71, 90, 91) controllable by the control unit (20), the control valves (70, 71, 90, 91) of the different brake circuits (12, 12′) can preferably be controlled or regulated independently of one another, and the brake valve (60) is preferably designed as a two-circuit brake valve (60).
